(19) United States
(12) Patent Application Publication
(10) Pub. No.: US 2011/0314101 A1
(43) Pub. Date: Dec. 22, 2011

(54) MANAGEMENT, ANALYTICAL AND DISTRIBUTION TOOL FOR DELIVERING CONTENT TO SOCIAL MEDIA NETWORKS

(75) Inventors: Terry Scot Redmon, Westlake, TX (US); Jimmy Ray James, Westlake, TX (US); Yuri Lite Star, Keller, TX (US); Travis John Gates, Keller, TX (US)

(73) Assignee: RainCloud Media, LLC, Southlake, TX (US)

(21) Appl. No.: 13/163,883

(22) Filed: Jun. 20, 2011

Related U.S. Application Data
(60) Provisional application No. 61/356,455, filed on Jun. 18, 2010.

(51) Int. Cl. G06F 15/16

(52) U.S. Cl. 709/204

(57) ABSTRACT

A method of distributing content over multiple social media networks and providing analysis based thereon is disclosed herein. Additionally, an apparatus for carrying out the method are disclosed. In one embodiment the apparatus includes: (1) a content publisher configured to automatically distribute content over multiple social media networks according to a delivery schedule; and (2) an action analyzer configured to monitor, on at least one of the social media networks, reaction to the content that has been distributed and generate a stimulus report based on the reaction according to a selectable format.

### CROSS-REFERENCE TO RELATED APPLICATION

This application claims the benefit of U.S. Provisional Application Ser. No. 61/356,455 filed on Jun. 18, 2010, entitled “MANAGEMENT, ANALYTICAL AND DISTRIBUTION TOOL FOR DELIVERING CONTENT TO SOCIAL MEDIA NETWORKS,” commonly assigned with this application and incorporated herein by reference.

### TECHNICAL FIELD

This application is directed, in general, to the distribution of content (also referred to as data) and, more specifically, to managing the delivery of content to social media networks and analyzing the impact of the delivered content.

### BACKGROUND

Various social media networks are available that provide an infrastructure for the interaction of users. Typically the social media networks are Web-based applications that provide an avenue for communication between users and sharing of different content (e.g., different types of media) between the users. Through social media networks, users can share various types of content including texts, photographs, videos, graphics, audio files and maps. Examples of existing social media networks include Facebook, Twitter, Vimeo and YouTube.

In addition to individual users, organizations such as businesses, churches or other non-profit groups, often use social media networks for communicating with customers, clients or members. The size and logistical requirements of the organizations may vary. For example, some of the organizations may have multiple teams in multiple locations and have significant amounts of media assets to be delivered through one or multiple social media networks.

Managing the delivery of content via a single social media network can be cumbersome. For organizations, this can be even more cumbersome especially when multiple types of content are to be delivered. The delivery of the content is even more difficult when it is to be delivered through multiple social media networks. In addition to managing and delivering the content through the various social media networks, monitoring and analyzing the impact of the delivered content can also be challenging.

### SUMMARY

In one aspect, the disclosure provides an apparatus. In one embodiment the apparatus includes: (1) a content publisher configured to automatically distribute content over multiple social media networks according to a delivery schedule; and (2) an action analyzer configured to monitor, on at least one of the social media networks, reaction to the content that has been distributed and generate a stimulus report based on the reaction according to a selectable format.

In another aspect, the disclosure provides a method of distributing content over multiple social media networks and providing analysis based thereon. In one embodiment, the method includes: (1) receiving approval for distribution of content over the social media networks, (2) automatically distributing the content over the multiple social media networks after receiving the approval and according to a delivery schedule, (3) monitoring, on at least one of the social media networks, reaction to the distribution of the content and (4) generating a stimulus report based on the reaction.

### BRIEF DESCRIPTION

Reference is now made to the following descriptions taken in conjunction with the accompanying drawings, in which:

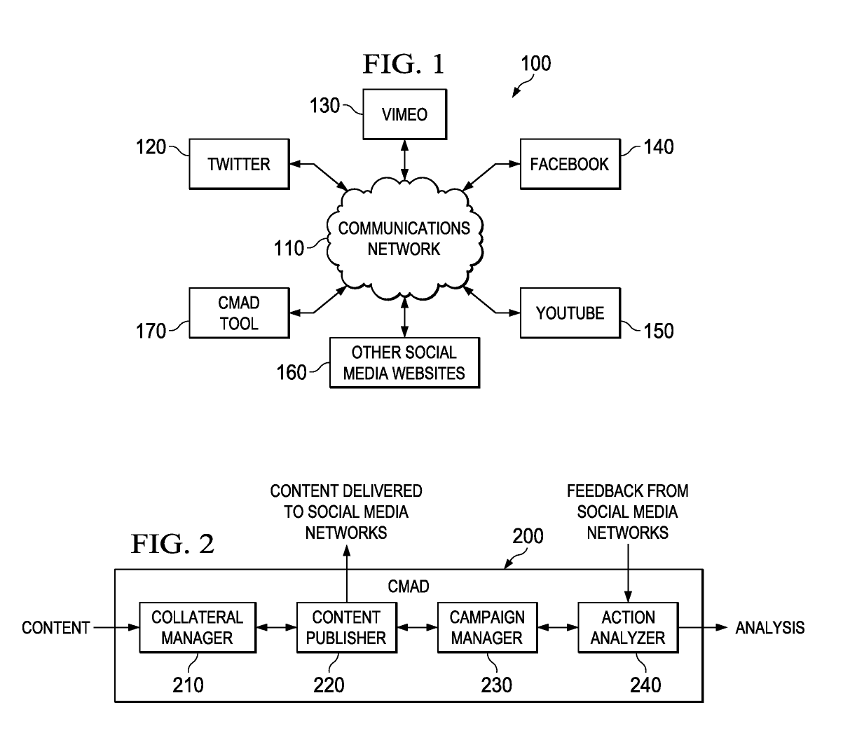

FIG. 1 illustrates a communications system including a content management, analytic and delivery (CMAD) tool constructed according to the principles of the disclosure;

FIG. 2 illustrates a block diagram of an embodiment of a CMAD tool constructed according to the principles of the disclosure;

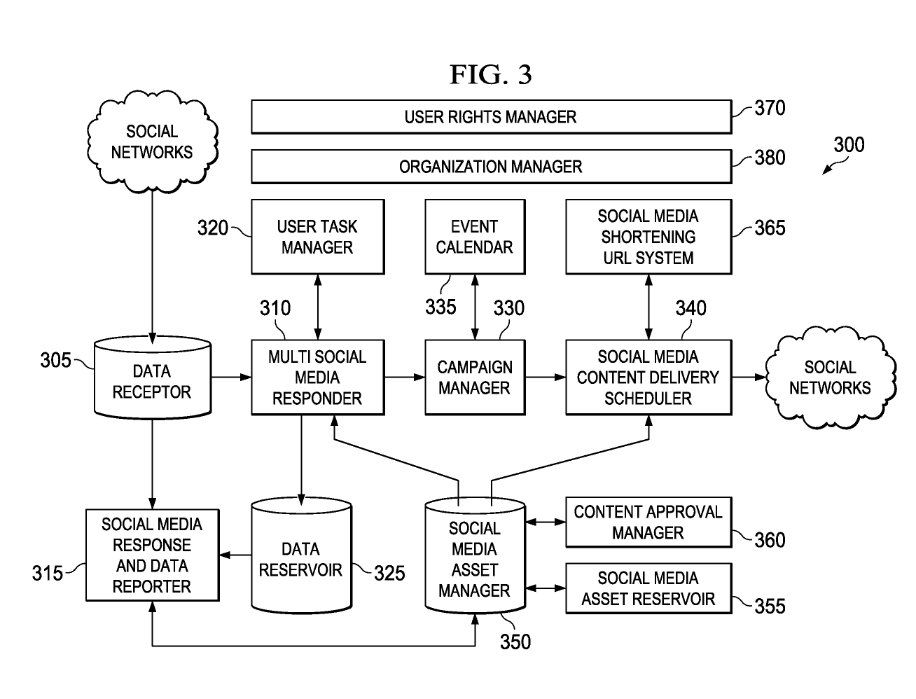

FIG. 3 illustrates a functional diagram of an embodiment of a CMAD tool constructed according to the principles of the disclosure; and

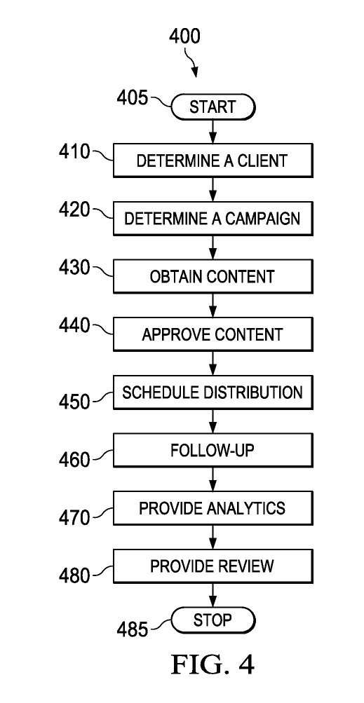

FIG. 4 illustrates a flow diagram of an embodiment of a method of distributing content over multiple social media networks and analyzing the reaction to the distributed content carried out according to the principles of the disclosure.

### DETAILED DESCRIPTION

Disclosed herein is a CMAD tool that can distribute content through multiple social media networks and analyze the impact of the content that was delivered to the various recipients. In addition to being compatible with multiple social media networks, the CMAD tool provides a single product solution that is scalable between individuals and large organizations.

The CMAD tool may be used as an integral part of any social media strategy employed to disseminate content. Examples of organizations that may advantageously use the CMAD tool for various social media strategies include: advertising companies, public relation firms, businesses, churches, ministries, non-profit groups and political groups. Examples of use for the CMAD tool include: public relations campaigns, advertising campaigns, political campaigns, product releases, surveys, public safety campaigns and weather warning systems. Public safety campaigns may include Homeland Security updates and warnings.

FIG. 1 illustrates a communications system 100 including a CMAD tool 170 constructed according to the principles of the disclosure. The communications system 100 includes a communications network 110 and various websites that offer social networking services. A few of the websites are specifically noted as Twitter 120, Vimeo 130, Facebook 140 and YouTube 150. Additional websites that provide social networking services are represented by social media websites 160. The other social media websites 160 may include websites that are mainly associated with particular countries, such as Nexopia in Canada and Tuenti in Spain, or websites that are associated with particular groups, such as Scispace.net for scientist and CafeMom for mothers.

The communications system 100 also includes the CMAD tool 170. The CMAD tool 170 is configured to provide a single interface to the various social media networking services and provide a conduit to distribute content thereto and monitor reaction to the receipt of the distributed content. The content may be different types of data or media including texts, photographs, videos, graphics, audio files and maps. The reaction is an action in response to receiving the distributed content including opening, deleting, forwarding and commenting on the received content. The CMAD tool 170 is also configured to generate a stimulus report based on the detected reaction. The stimulus report may be generated according to a selectable format that may be predetermined or user selected at the time of generation. Additional functionality of the CMAD tool 170 will be discussed with respect to the other illustrated embodiments.

The CMAD tool 170 may be implemented as a series of operating instructions stored on a non-transitory computer-readable medium that directs the operation of a computing device, such as a processor, when executed thereby. The CMAD tool 170 may be an apparatus, such as a server, that includes the necessary circuitry or series of operating instructions to perform the disclosed functionality of the CMAD tool 170. The server may be a dedicated server or may include other applications.

The CMAD tool 170 may be coupled to the communications network 110 employing conventional connections. The communications network 100 is a collection of components and devices that are connected together to enable communication therebetween. The communications network 100 may be a conventional network that is used to communicate data. The communications network 100 may be or include a computer network, a telephone network, or a combination thereof. In one embodiment, the communications network 100 may be the Internet.

FIG. 2 illustrates a block diagram of an embodiment of a CMAD tool 200 constructed according to the principles of the disclosure. The CMAD tool 200 may be implemented as a series of operating instructions stored on a non-transitory computer-readable medium that directs the operation of a computing device, such as a processor, when executed thereby. The non-transitory computer-readable medium may be distributed over multiple devices, machines, etc., or contained within a single apparatus. The CMAD tool 200 may be an apparatus, such as a server, that includes the necessary circuitry or series of operating instructions to perform the disclosed functionality of the CMAD tool 200. The CMAD tool 200 includes a collateral manager 210, a content publisher 220, a campaign manager 230 and an action analyzer 240. One skilled in the art will understand that the described functions of each of these components of the CMAD tool 200 may be interchanged and are not restricted thereto. As such, in some embodiments, the various functions may be performed by different components as described herein or may be performed in parts by multiple of the components of the CMAD tool 200.

The collateral manager 210 is configured to store and manage content that can be distributed over social media networks. The collateral manager 210 provides an online warehouse of digital assets, i.e., content, that a user can upload for distribution. In this disclosure, uploading the content refers to queuing content for distribution wherein the content has already been approved. The content may be assigned to a campaign or can be made available for use in all campaigns. Additionally, the content can be copied from one campaign to another. The collateral manager 210 may provide folders for organizing the content into desired groups or campaigns.

The collateral manager 210 is configured to allow a user to tag each piece of content with identification data. The content may be tagged such information as title, caption, last updated, content type, status (approved, rejected, or pending), common response (yes or no) and for use with designated campaigns (the assigned campaigns). The collateral manager 210 may maintain the identification data with the content during storage thereof. In some embodiments, the collateral manager 210 may maintain the identification data even after it has been distributed. The collateral manager 210 may keep the content available until a user or administrator manually deletes it. In addition to storing content, the collateral manager 210 may also be configured to store corresponding data for each piece of distributed content. The corresponding data is gathered from the monitored reaction and may be stored for analysis.

The collateral manager 210 may include an interface for receiving the content. The interface may be a conventional component or device that is used to download content from a communications network or upload content from a portable memory device such as a camera, a laptop, a smart phone or a memory stick. The interface may also be a user interface such as a keyboard, a touch screen or a microphone that allows manual input of content.

In one embodiment, the collateral manager 210 includes a template that allows users to populate particular cells that correspond with text fields within the CMAD tool 200. For example, the text fields may correspond to the identification data. When content is imported, the collateral manager 210 may display multiple pieces of content for preview and approval. The template may also be used to schedule and assign the content to particular social media channels when being loaded into the collateral manager 210. Additionally, the collateral manager 210 may provide a preview function that allows users to view information for each piece of content by hovering over the title wherever it may appear on a display associated with, e.g., coupled to, the CMAD tool 200. The preview function may include the copy/picture/link to video and the various information data. The collateral manager 210 may store the content, whether approved, unapproved or pending, until it is deleted.

The collateral manager 210 includes a content approval protocol structure configured to limit distribution of the content until designated approvals are obtained. The content approval protocol structure is configured to provide a flexible approval structure that allows for both nestled approvals and group approvals. For nestled approvals, the approval structure includes a linear order of approval before content becomes available to distribute. For example, if Person A approves the content for distribution, Person B is notified and, in some embodiments, must approve the content for distribution before the content is even available for approval by Person C. In one embodiment, all content may be subject to the same chain of approval before distribution. In other embodiments, different chains of approval may be employed depending for example, on the content or the campaign. An administrator of the CMAD tool 200 may alter the various permissions. The limit for nestled approvers within the content approval protocol structure is undefined. As such, there could be “n” number of approvals required before distribution.

In group approvals, the content approval protocol structure may require the approval of a designated number of people, out of a larger assigned group before content is available to distribute. For example, three people out of a defined group of seven people, may be required to approve content (in no particular order) before content is available to distribute. In some embodiments, the administrator may disable the content approval protocol structure. Accordingly, neither the linear or group approval protocol may be required by the collateral manager 210.

The content approval protocol structure may include permission levels assigned to different tasks associated with the content. For example, varying levels of permissions can be assigned to individual users or groups of users. Certain users may be assigned permission to upload content, approve content, edit content, schedule content and access analytics assigned to content.

To obtain approvals and coordinate approval status among users, the collateral manager 210 is configured to initiate notifications regarding the approval status of content. Accordingly, the collateral manager 210 is configured to send content pending approval notification, content rejection notifications and content approval notifications. The content pending approval may appear as a “To Do” in all indicated areas for each user with approval permission. Additionally, the collateral manager 210 may generate a message, such as an e-mail, to needed users for each piece of content needing approval. Similarly, a content rejection notification may be provided. The collateral manager 210 may send a message and/or provide that content declined approval appear as a “To Do” in all indicated areas for each user with approval permission. Content approval notification may allow scheduling of the content for distribution and notification of approval for each piece of content. The various “To Do” notifications may be provided, for example, in a list or a calendar for a particular user or users.

The content publisher 220 is configured to automatically distribute content over multiple social media networks according to a delivery schedule. The content publisher 220 provides a single platform that is configured to distribute (i.e., publishes) content such as text, pictures, videos and links to one or multiple social media channels. The content publisher 220 may provide a template to allow a user to schedule distribution of certain content on a particular social media network or networks. The content publisher 220 may schedule to distribute the content immediately or at a specified time on a particular date. Distribution of the content may be subject to the content approval protocol structure. In some embodiments, the approval protocol structure may be disabled.

In addition to automated distribution, the automated publisher 220 may be configured to provide automated activity failure notifications. As such, the automated publisher 220 is configured to generate notifications to users to notify them of any scheduled activities that have not been executed successfully. The automated failure notifications may be sent as messages such as e-mails, may appear in a user dashboard provided by the campaign manager 230 or may be generated as scheduled activity summaries from the automated publisher 220. The e-mails may be sent from stored contact information within the CMAD tool 200. A Really Simple Syndication (RSS) feed (i.e., a RSS document) may also be provided.

The content publisher 220 may also be configured to generate responses to activity detected on a social media network or networks according to an area of interest. The content publisher 220 may be configured to allow a user to generate a real-time response to detected activity. With the content publisher 220, the user can respond to activity in a social media network across social media channels from a single platform. The level of interaction may depend on the particular social media network in which the activity was selected or the social media network selected by the user to send out the response.

In addition to providing a real time response, the content publisher 220 allows a user to send a custom or approved response. Depending on a level of permission, users can respond to social media activity with a custom reply, published in the designated social media channel via the content publisher 220. Alternatively, depending on a level of permission, users can respond to social media activity with a pre-approved response, published in the designated social media channel via the content publisher.

When distributing the content, the content publisher 220 may be configured to replace Uniform Resource Locators (URLs) associated with recipients of distributed content with unique abbreviated URLs. The content publisher 220 may replace the URLs by generating a unique abbreviated version that the action analyzer 240 can use to pull back analytics for reporting. The action analyzer 240 may also pull back analytics without employing an abbreviated URL by using other recipient identification information. The recipient identification information may be, for example, “referrer information.” Referrer information is commonly used with web pages and communications over networks. The referrer information may include, for example, a conventional URL. One skilled in the art will understand referrer information.

The action analyzer 240 may gather the referrer information from the reaction of the content recipients. For example, the action analyzer 240 may gather the referrer information from each person that clicks on a link or accesses a piece of the distributed content. The action analyzer 240 can then process and store the received referrer information and employ it to generate analytics.

The content publisher 220 may generate the unique abbreviated URL from the referrer information that is gathered by the action analyzer 240. A conversion table may be created to associate abbreviated URLs with the corresponding referrer information. In some embodiments, the action analyzer 240 may be employed to generate the unique abbreviated URLs.

The campaign manager 230 is configured to coordinate the distribution of the content over the social media networks. The content may vary and may be associated with different campaigns. Management of multiple campaigns can be achieved through the campaign manager 230. Users, therefore, have the ability to launch and monitor more than one campaign, running simultaneously, from a single platform. A campaign is a collection of actions directed to a particular goal. For example, a book promotion may be a campaign.

The campaign manager 230 provides a customizable calendar to organize and schedule one or more campaigns to deliver content. Users can populate the customizable calendar with campaign start dates, scheduled activity, reminders and campaign end dates. Users can sort activity by campaigns. The calendar can be viewed by day, week or month. A user may select which view. The campaign manager 230 can generate reminders from the calendar that appear for each user (based on permissions) in the user dashboard as well as e-mail notification.

The campaign manager 230 provides an interface that allows a user or an administrator to interact with the CMAD tool 200. For example, the campaign manager 230 may provide a dashboard for the CMAD tool 200. The campaign manager 230 also provides an interface and coordinates operation between the various functionalities of the CMAD tool 200. For example, the campaign manager 200 coordinates the approval, scheduled publishing and analysis across the social media cloud for the CMAD tool 200. Additionally, the campaign manager 230 can be configured to allow communication within a social media network to be segmented by a user or by a specific criteria. A filter tool of the campaign manager 230 may be configured to control the segmented communications based on a user ID or denoted criteria (e.g., a particular task or content). The campaign manager 230 can also be configured to integrate purchased advertising with the content for delivery. For example, delivered content could point back to a page that has a paid advertisement. Additionally, the content itself may be or may include an advertisement that can be distributed.

The action analyzer 240 is configured to monitor, on at least one of the social media networks, reaction to the distributed content and generate a stimulus report based on the reaction. The stimulus report may be generated according to a selectable format. The action analyzer 240 provides analysis of the detected reaction to generate the stimulus report. As such, the action analyzer 240 is configured to monitor the impact of distributed content, analyze the efficacy thereof and generate reports based on the analysis. The reaction may be an action such as opening, deleting, forwarding or commenting on the content. The reaction may be monitored on a different social media network than the content was distributed. For example, content may be distributed over Twitter and a reaction detected on Facebook. A table may be created to associate a user's identification in the various social media networks for both monitoring and distribution. Accordingly, the CMAD tool 200 can monitor any social media network in which it is attached regardless over which social media network content is distributed. The stimulus report may be a summary of social media efficacy for users and may depend on permission levels.

The action analyzer 240 is also configured to monitor social media activity across channels of interest. Data points are gathered and activity reports are generated or updated for users. The updating of reports for certain users may be based on permission levels. The data that is stored can vary according to the guidelines of each social media network that is being monitored. The data that is stored for indicated points of interest may be stored in the collateral manager 210.

The reports generated by the action analyzer 240, including the stimulus and the activity reports, may be customized reports. The action analyzer 240 may be configured to allow users to access data stored in the collateral manager 210 to generate reports of past and current performances. Via the action analyzer 240, users can select formats for the presentation of the data and initiate exporting of the reports. For example, the action analyzer 240 can interface with iPhone applications that allow a user to access reporting for analysis. Other applications may also be interfaced via the action analyzer 240 to allow users to access reporting for analysis (e.g., widget analytics). For example, a widget can be configured to read content delivered by the campaign manager 230 and anyone that has the widget installed will automatically get the delivered content.

The action analyzer 240 may also generate reports based on activity observed from the unique abbreviated URLs. In one such report, the action analyzer 240 can provide a dynamic map of global activity corresponding to the unique abbreviated URLs. The action analyzer 240 can also generate maps for reporting that are based on Geo Data, IP addresses and/or other recipient identification information provided by the various social media networks.

Additionally, the reports can be universal reports that allow viewing of analytics based on social media activity throughout the social media cloud (i.e., a collection of social media networks). Reports to view analytics based on individual social media networks is also provided. The generated reports may be real-time based on the latest obtained data or based on stored data. The various types of reports can be provided via a display connected to the CMAD tool 200, sent to a printer and/or other devices upon which the reports may be displayed (e.g., a smart phone).

FIG. 3 illustrates a functional diagram of an embodiment of a CMAD tool 300 constructed according to the principles of the disclosure. Wherein FIG. 2 illustrates the various components of an embodiment of a CMAD tool, FIG. 3 illustrates the internal interaction of different functions of the CMAD tool 300 and the external interaction of the CMAD tool 300 with social media networks with respect to receiving data from the social media networks and distributing content and responses thereto. The components of the CMAD tool 200 may interact to perform the various functions of FIG. 3.

Data from a social media network or networks is received at a data receptor 305. The received data may be monitored reaction to distributed content. Additionally, the received data may be activity that has been detected with respect to a designated area of interest. For example, a user may instruct the CMAD tool 300 to monitor the social media network or networks for comments, searches, tweets, inquiries, etc., with respect to estate planning in a particular metropolitan area. The CMAD tool 300 can then monitor the social media cloud for activity with regard to estate planning in the metropolitan area and gather that data for analysis and for sending responses.

The received data is delivered to a multi-social media responder 310 and a social media response and data reporter 315. The multi-social media responder 310 determines a response to send in reply to the detected activity or to a detected reaction. The response may be an approved response that has already been generated and approved as a reply. The approved response may be a generic response that can be used to reply to inquiries or comments about a particular area of interest. For example, a tweet may have been detected commenting on the music of a particular artist. An approved response, such as, “thanks for your support” may be sent in reply. A signature line may be used with the response to indicate it is from a particular person or organization.

The multi-social media responder 310 may also interact with a user task manager 320 to generate a custom response that may be communicated. Regardless of the type of response, a response can be generated in real-time and communicated to the person who generated the activity or reaction. In some embodiments, a response may be sent over a different social media network than the activity was detected. For example, the activity may be detected on YouTube and a response may be sent over Twitter. A table that associates a user's various IDs for the social media networks may be used to send responses over different social media networks.

The response and the data from the social media networks are delivered to a data reservoir 325. The data reservoir 325 stores corresponding data for each piece of distributed content, responses and the data. This stored information is provided to the social media response and data reporter 315 that is configured to generate reports based on the information.

The multi-social media responder 310 also provides the responses to a campaign manager 330. The campaign manager 330 coordinates the delivery of the responses for the CMAD tool 300. The campaign manager 330 may interact with an event calendar 335 to coordinate delivery of the responses. The campaign manager 330 provides the responses and delivery instructions to a social media content delivery scheduler 340 for communicating the response to a social media network.

In addition to receiving responses from the campaign manager 330, the social media content delivery scheduler 340 receives content from a social media asset manager 350. The social media asset manager 350 receives content from the social media asset reservoir and importer 355. Additionally, the social media and asset manager 350 receives approval information from a content approval manager 360. The approval information may be based on a content approval protocol structure. The social media asset manager 350 may control the delivery of content to the social media content delivery scheduler 340 based on the protocol information.

The content and information data associated therewith may be provided to the social media response and data reporter 315 from the social media asset manager 350 to generate various reports. The social media response and data reporter 315 may also provide feedback to the social media asset manager 350 based on the generated reports, detected data and responses. The social media asset manager 350 may employ the feedback to provide intelligence for distributing the content.

The social media asset manager 350 may also provide content or content information to the multi-social media responder 310. The provided information may be used by the multi-social media responder 310 in generating responses or in sending communication information to the campaign manager 330.

The campaign manager 330 may send distribution directions to the social media content delivery scheduler 340 for distributing content. The distribution directions may be generated from the event calendar 335. The social media content delivery scheduler 340 may interact with a social media shortening URL system 365 when distributing content and/or response. The social media shortening URL system 365 generates unique abbreviated URLs that can be used when delivering the content or responses. Data from the social media networks may then be gathered according to the unique abbreviated URLs. The social media response and data reporter 315 can then generate reports based on the data gathered from the unique abbreviated URLs.

The CMAD tool 300 also includes a user rights manager 370 and an organization manager 380. The user rights manager 370 and the organization manager 380 are used to set and control access and operation of the CMAD tool 300 with respect to individual users and to a particular organization or organizations that are employing the CMAD tool 300. Permission levels and logon information may be provided to direct access to the various functions of the CMAD tool 300. The access rights for users may vary with respect to different organizations. Operation and interaction of the various functions of the CMAD tool 300 may vary according to the setting established in the user rights manager 370 and the organization manager 380.

FIG. 4 illustrates a flow diagram of an embodiment of a method 400 of distributing content over multiple social media networks and analyzing the reaction to the distributed content carried out according to the principles of the disclosure. The method 400 represents managing a particular campaign for a book promotion for a client, Demo, Inc. The method 400 corresponds to a user employing a CMAD tool to manage the particular campaign. Accordingly, a CMAD tool may perform each of the steps of the method 400. The method begins in a step 405. The method 400 may begin upon receipt of login information such as a username and a password entered by a user. A conventional user interface may be used to enter the login information.

In a step 410, a client is determined for the particular campaign. The client may be determined per user input. A list of potential clients may be provided for selection by a user or a new client may be entered by the user. As noted above, in this example the client is determined to be Demo, Inc.

A campaign is determined in a step 420. In some embodiments, the campaign for the particular client may be determined based on user input from, for example, a keyboard, or from selecting a campaign from a drop-down list. The CMAD tool may provide a dashboard as an interface for the user to assist in determining the client and the campaign. For example, the dashboard may provide a list of campaigns for the client Demo, Inc. that includes “Book Promotion.” The CMAD tool may receive a selection of the “Book Promotion” via a mouse-click from the user.

Content for the campaign is obtained in a step 430. The CMAD tool may receive new content for the campaign or may retrieve content that has already been stored with the CMAD tool. The dashboard may be used to allow selection of stored content or the addition of new content. For example, the dashboard may receive an “Add New Content” instruction and provide a Content Screen that allows selection of the particular campaign (Book Promotion) and identification of the new content. The new content may be identified by name, description, plain text and relevant URLs. A social media shortening URL system 365 may be used to generate identification for or pair an identifier with the content. After receiving the identification information, the CMAD tool can receive an input by a user that submits the information for processing or loading. If the content to obtain is already stored, the dashboard may provide an “Import Content” option that allows a user to choose a template file of the content, preview the content and, if desired, retrieve the content for use.

Approval of the content is received in a step 440. The received approval or approvals may be based on a content approval protocol structure. A linear approval or a group approval structure may be employed by the CMAD tool. The CMAD tool may interact with a user to receive the necessary approvals. For example, a “To Do” list may be provided for a user. From the “To Do” list, such as a “To Do List” dashboard, the users or users may approve or reject items in an “Approval Section.” The approvals or rejections for content may be individually or in a group. For linear approval, the CMAD tool can make the obtained content available for distribution when all members of a sequential predetermined protocol entered their approval. For a group approval, the CMAD tool can make the obtained content available for distribution upon receipt of the approvals from x number of members of approvers in a predetermined approver group. The designated number of approvers needed (x number) for review and approval of the content may do so in no particular order.

After receiving the proper approvals, the content is scheduled for distribution in a step 450. The CMAD tool may provide a “Jump to a Campaign” option that allows a user to select a campaign, e.g., “Book Promotion.” From a user dashboard, a selection of “New Automated Activity” can be received. Additionally, selections for “Post Text”, “Upload Image” or “Upload Video” may be received depending on the content to distribute.

After receiving selections for, for example, “Post Text,” selections for relevant social media channels may be received. Additionally, selections for a scheduled date and time for distribution of the selected content can be received. Particular users may also be notified of the scheduled distribution. The users may be selected and the notification may be provided on a calendar of the user or users. A final acceptance of the scheduled delivery may be received by the CMAD tool for distribution of the content.

Follow-up of from distribution of the content is coordinated in a step 460. The CMAD tool may be employed to review channel activity, respond to interactive elements and assign follow-up items to various team members or users. The CMAD tool may also coordinate review of the assigned follow-up items. The activity, interactive elements and reaction gathered from the various social media channels may include comments, “Likes,” “Retweets,” mentions, designated keyword searches and other actions or behavior that is associated with the different social media networks.

Analytics from the distributed content is generated in a step 470. The CMAD tool may generate reports after analyzing the reactions and/or activity on the social media networks. The provided analytics can be viewed as, for example, graphs, charts or data tables. The analytics may be exported by the CMAD tool to other applications or devices.

In a step 480, a review of the reaction from the distributed content is provided. The review may be provided as a map of campaign activity that is generated in real time based on unique abbreviated URLs. For example, a user may select “Jump to a Campaign” and “Book Promotion” for a provided dashboard. A selection of “Map of Campaign Activity” can then be received to initiate the generation of the real-time map. The real-time map may illustrate the globe (e.g., a global map) or a portion of the globe and identify locations where reactions are noticed. Pins, for example, may be used to identify the various reaction locations. As such, various areas of state, country or the world may be visually identified as areas that have provided a reaction. Accordingly, the impact of certain content can be associated with different geographic locations. Planning can then be made based on this geographic information. The map may be dynamic such that changes can be seen in real-time as the map is being viewed. The method 400 then ends in a step 485.

The above-described apparatuses and methods may be embodied in or performed by various digital data processors or computers, wherein the computers are programmed or store executable programs of sequences of software instructions to perform one or more of the steps of the methods e.g., steps of the methods or processes of FIG. 4. The software instructions of such programs may represent algorithms and be encoded in machine-executable form on conventional digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods. Accordingly, computer storage products with a computer-readable medium, such as a non-transitory computer-readable medium, that have program code thereon for performing various computer-implemented operations that embody the tools or carry out the steps of the methods set forth herein may be employed. A non-transitory media includes all computer-readable media except for a transitory, propagating signal. As such, a computer program product, including a computer usable medium having a computer readable program code embodied therein, may be adapted to be executed to implement the methods disclosed herein, such as the method of FIG. 4. The media and program code may be specially designed and constructed for the purposes of the disclosure, or they may be of the kind well known and available to those having skill in the computer software arts. An apparatus, such as a server, may include the necessary circuitry and series of operating instructions to perform each step of the disclosed methods. In one embodiment, the particular functions described herein may be integrated with a processor such as a server.

Those skilled in the art to which this application relates will appreciate that other and further additions, deletions, substitutions and modifications may be made to the described embodiments.

What is claimed is:

1. An apparatus, comprising:
a content publisher configured to automatically distribute content over multiple social media networks according to a delivery schedule; and
an action analyzer configured to monitor, on at least one of said social media networks, reaction to said content that has been distributed and generate a stimulus report based on said reaction according to a selectable format.

2. The apparatus as recited in claim 1 wherein said delivery schedule is based on a content approval protocol for said content.

3. The apparatus as recited in claim 1 wherein said content publisher is configured to automatically distribute said content simultaneously.

4. The apparatus as recited in claim 1 wherein said reaction is selected from the group of actions consisting of:
opening said content,
deleting said content,
forwarding said content, and
commenting on said content.

5. The apparatus as recited in claim 1 wherein said content publisher is further configured to replace URLs associated with recipients of said content that has been delivered with unique abbreviated URLs.

6. The apparatus as recited in claim 5 wherein said action analyzer is configured to generate said stimulus report based on said unique abbreviated URLs.

7. The apparatus as recited in claim 6 wherein said selectable format for said report is a dynamic map of activity based on said unique abbreviated URLs.

8. The apparatus as recited in claim 1 wherein said action analyzer is further configured to monitor activity on said social media networks according to an area of interest.

9. The apparatus as recited in claim 8 wherein said content publisher is further configured to deliver a response to said activity.

10. The apparatus as recited in claim 8 wherein said action analyzer is further configured to generate an activity report based on said activity.

11. The apparatus as recited in claim 1 further comprising a collateral manager configured to store and manage said content.

12. The apparatus as recited in claim 11 wherein said collateral manager includes a content approval protocol structure configured to limit distribution of said content until designated approvals are obtained.

13. The apparatus as recited in claim 12 wherein said content approval protocol structure includes permission levels assigned to different tasks associated with said content.

14. The apparatus as recited in claim 11 further comprising a campaign manager configured to coordinate distribution of different content over said social media networks in separate campaigns.

15. A method of distributing content over multiple social media networks and providing analysis based thereon, comprising:
receiving approval for distribution of content over said social media networks;
automatically distributing said content over said multiple social media networks after receiving said approval and according to a delivery schedule;
monitoring, on at least one of said social media networks, reaction to said distribution of said content; and
generating a stimulus report based on said reaction.

16. The method as recited in claim 15 further comprising importing said content for said distribution.

17. The method as recited in claim 15 further comprising replacing URLs associated with recipients of said content that has been delivered with unique abbreviated URLs.

18. The method as recited in claim 17 wherein said stimulus report is based on said unique abbreviated URLs.

19. The method as recited in claim 15 wherein said content is associated with a single campaign.

20. The method as recited in claim 15 wherein said stimulus report is a dynamic map of activity.
